(19) United States
(12) Patent Application Publication
(10) Pub. No.: US 2025/0036381 A1
(43) Pub. Date: Jan. 30, 2025

(54) METHOD FOR OPTIMIZING A COMPUTER PROGRAM

(71) Applicant: Robert Bosch GmbH, Stuttgart (DE)

(72) Inventors: Daniel Schwarzer, Sindelfingen (DE); Paulius Duplys, Markgroeningen (DE)

(21) Appl. No.: 18/768,280

(22) Filed: Jul. 10, 2024

(30) Foreign Application Priority Data
Jul. 27, 2023 (DE) 10 2023 207 158.4

(51) Int. Cl. G06F 8/41; G06F 8/77

(52) U.S. Cl. CPC G06F 8/443; G06F 8/77

(57) ABSTRACT

A method for optimizing a computer program. For dividing the computer program into a plurality of program parts, the method includes ascertaining a respective metric value for each program part, sorting the program parts based on the metric values according to descending criticality of the program parts and processing the program parts in accordance with an order specified by the sorting by checking, for each program part to be processed and each criticality evaluation metric, whether the metric value of the criticality evaluation metric is above a predetermined threshold value associated with the criticality evaluation metric, and, if the metric value of the criticality evaluation metric is above the threshold value, initiating an optimization measure that is associated with the criticality evaluation metric.

### CROSS REFERENCE

The present application claims the benefit under 35 U.S.C. § 119 of German Patent Application No. DE 10 2023 207 158.4 filed on Jul. 27, 2023, which is expressly incorporated herein by reference in its entirety.

### FIELD

The present invention relates to methods for optimizing a computer program.

### BACKGROUND INFORMATION

One essential part of software application development is testing and, when errors or other weaknesses (such as low performance) are found, appropriate revision. In the case of larger computer programs, however, it is not feasible in practice to check or revise all parts of the program in detail.

Effective methods for optimizing computer programs that can be used in practice are therefore desirable.

### SUMMARY

According to various example embodiments of the present invention, a method for optimizing a computer program is provided, which, for dividing the computer program into a plurality of program parts, comprises:
ascertaining a respective metric value (also referred to in the embodiment examples as mᵢ) for each program part based on one or more criteria for each criticality evaluation metric of a plurality of criticality evaluation metrics, wherein each criticality evaluation metric is assigned an optimization measure (e.g. decomposing the program part (e.g. a large function into multiple small functions), changing a library function being used (e.g. copy_n instead of copy), etc.);
sorting the program parts based on the metric values according to descending criticality of the program parts (e.g. by ascertaining an (overall) criticality value for each program part by summing the metric values of the program part and sorting the program parts (in descending order) according to the criticality values), and
processing the program parts in accordance with an order specified by the sorting by checking, for each program part to be processed and each criticality evaluation metric, whether the metric value of the criticality evaluation metric is above a predetermined threshold value associated with the criticality evaluation metric, and, if the metric value of the criticality evaluation metric is above the threshold value, initiating an optimization measure that is associated with the criticality evaluation metric.

The above-described method enables automatic improvement of program parts (e.g., program code locations or program code areas, such as certain functions, classes or methods, or also program parts contained in certain files), which are most likely to contain implementation errors or architectural or design flaws, in particular with regard to their (program) code quality. This in particular enables efficient improvement of the computer program in terms of effort and benefit: Particularly important program parts are improved, e.g., because they form the core of the functionality of the respective software and, due to their complexity, are highly likely to contain errors.

“Optimizing” is not intended to be understood to mean that the computer program is necessarily optimal after the method has been carried out. It is rather intended to mean that it behaves better according to certain quality criteria (such as number of errors, execution time (e.g., by removing bottlenecks) etc.) after the method has been carried out. The “optimization measures” can also be regarded as “improvement measures” or “revision measures” (or “actions”).

According to various example embodiments of the present invention, program parts with the highest probability of quality problems (based on the values of the criticality evaluation metrics) are identified. This is done by using a plurality of criticality evaluation metrics, each of which is based on one or more respective criteria, e.g., one or more combinations of:
criticality indicators based on developer behavior and code evolution (e.g. information from version control protocols),
empirical criticality indicators (e.g. how much experience does Developer A have with a particular type of code or task?),
criticality indicators based on the structure and architecture of the codebase (e.g. which parts of the codebase process user inputs? Where are the APIs that can be accessed from the outside?), and
criticality indicators based on program analyses (e.g. results from a static code analysis tool or a fuzzing tool).

Program parts can be sorted according to their criticality based on the criticality evaluation metric values. Revision measures can then be initiated accordingly (e.g. at code level, architecture level and process level) i.e. a revision of the code can be initiated for a subset of the most critical program parts (i.e. for those for which a correction makes the most sense, in particular with regard to the effort-to-benefit ratio) (e.g. a revision tool that automatically rewrites the code or at least makes suggestions can be started, or a general recommendation can be made to one or more developers (such as “decompose function”, “use another library” etc.), so that a good benefit to effort ratio can be achieved. According to various embodiments, this recommendation or initiation (and possibly at least in part the revision measure) takes place automatically.

Various embodiment examples of the present invention are specified in the following.

Embodiment example 1 is a method for optimizing a computer program as described above.

Embodiment example 2 is a method according to embodiment example 1, wherein the one or more criteria are one or more of a frequency of changes to the program part, an evaluation by one or more programmers associated with the program part (i.e. for whom it is indicated that the program part originates from them), an error frequency of the program part, a frequency of execution of the program part during an execution of the computer program, an evaluation of the size of the circle of programmers to which the program part is exposed in terms of possible changes (i.e. how much the program part is exposed), a degree of dependencies of the program part on other parts of the computer program and a complexity of the program part.

According to various embodiments, in particular the evaluation of a respective or multiple respective programmers is taken into account (e.g. their experience (in general or with respect to a property of the program part (e.g. the programming language used for its programming or its functionality (e.g. communication, cryptography, etc.)).

Embodiment example 3 is a method according to embodiment example 1 or 2, wherein the criticality evaluation metrics combine and/or weight the criteria differently.

This makes it possible to implement different criticality indicators and evaluations; for example a high criticality could be indicated by the fact that a program part has a high complexity and the program part is highly exposed.

Embodiment example 4 is a method according to one of embodiment examples 1 to 3, wherein the optimization measures assigned to the criticality evaluation metrics are one or more of a revision and/or review at implementation level (i.e. e.g. at code level), a revision at architecture level (i.e. a decomposition of a function into subfunctions), an error analysis, a change of the programming language used for the program part and a verification of the program part with a specific test, validation, and/or verification procedure.

This makes it possible to cover a wide range of optimization options.

Embodiment example 5 is a method according to one of embodiment examples 1 to 4, wherein the computer program is a control program for a robot device, and the robot device is controlled with a version of the computer program that is generated by the optimization measures initiated by the processing of the program parts.

Embodiment example 6 is a data processing device configured to carry out a method according to one of embodiment examples 1 to 5.

Embodiment example 7 is a computer program comprising instructions that, when executed by a processor, cause said processor to carry out a method according to one of embodiment examples 1 to 5.

Embodiment example 8 is a computer-readable medium which stores instructions that, when executed by a processor, cause said processor to carry out a method according to one of embodiment examples 1 to 5.

In the figures, like reference signs generally refer to the same parts throughout the different views. The figures are not necessarily to scale, wherein emphasis is instead generally placed on representing the principles of the present invention.

In the following description, various aspects are described with reference to the figures.

### BRIEF DESCRIPTION OF THE DRAWINGS

FIG. 1 shows a computer for developing and/or testing software applications.

FIG. 2 illustrates the ascertainment of revision measures for a computer program using a revision tool.

FIG. 3 shows a flowchart 300 illustrating a method for optimizing a computer program according to an example embodiment of the present invention.

### DETAILED DESCRIPTION OF EXAMPLE EMBODIMENTS

The following detailed description relates to the figures, which, for clarification, show specific details and aspects of this disclosure in which the present invention can be implemented. Other aspects can be used, and structural, logical, and electrical changes can be carried out without departing from the scope of protection of the present invention. The various aspects of this disclosure are not necessarily mutually exclusive since some aspects of this disclosure can be combined with one or more other aspects of this disclosure to form new aspects.

Different examples will be described in more detail in the following.

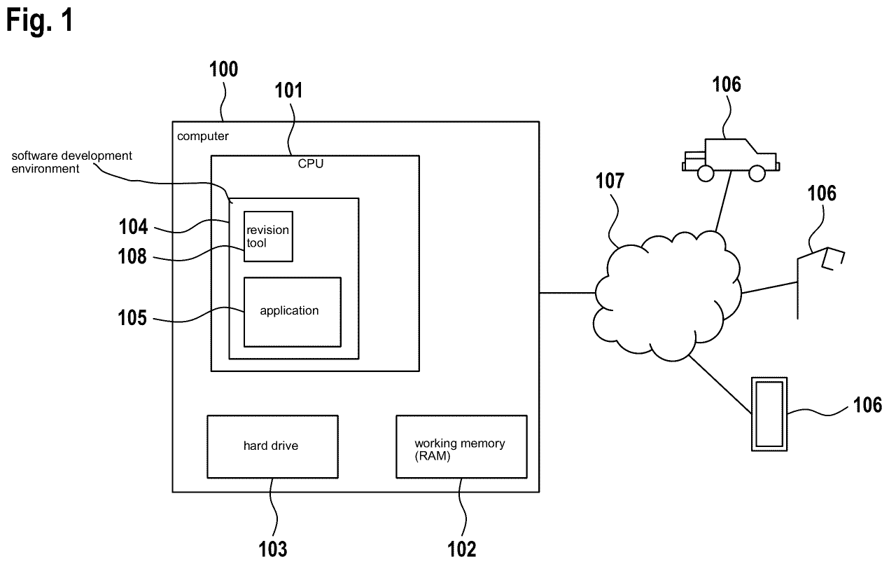

FIG. 1 shows a computer 100 for developing and/or testing software applications.

The computer 100 comprises a CPU (central processing unit) 101 and a working memory (RAM) 102. The working memory 102 is used to load program code, e.g. from a hard drive 103, and the CPU 101 executes the program code.

This example assumes that a user intends to use the computer 100 to develop and/or test a software application.

To do so, the user executes a software development environment 104 on the CPU 101.

The software development environment 104 enables the user to develop and test an application 105 for different devices 106, i.e., target hardware, such as embedded systems for controlling robot devices, including robot arms and autonomous vehicles, or also for mobile (communication) devices. For this purpose the CPU 101 can execute an emulator as part of the software development environment 104 to simulate the behavior of the respective device 106 for which an application is being or has been developed. If it is used only to test software from another source, the software development environment 104 can also be considered or configured as a software test environment.

The user can distribute the finished application to corresponding devices 106 via a communication network 107. Instead of a communication network 107, this can also be done in other ways, for example using a USB stick.

Before this happens, however, the user should test the application 105 to avoid distributing an improperly functioning application to the devices 106; i.e. the code quality of the application 105 should be ensured.

Ensuring code quality at both the implementation level (i.e. error-free code) and the architecture level (i.e. error-free code) is an important task, and will become even more important in the future as value-added functions are increasingly implemented in software. A software manufacturer can even be contractually obligated to support software for a period of time for an extended period of time, so that high code quality is of major interest to the developer.

Code quality can be examined using program analysis techniques. Examples of such techniques include static code analysis, fuzzing, symbolic execution, and concolic execution. While all of these techniques find errors, they are typically applied to the entire codebase of a software project (they could also be applied to individual classes or modules, but that then begs the question how to decide which classes or modules to check). This is fruitless, because quality problems are usually distributed unevenly across the codebase: complex code, or code that is changed frequently, is much more likely to have quality problems than simple, well-understood and rarely changed code. Moreover, for large software projects, this is not feasible in practice.

According to various embodiments, an approach for automatically identifying the most important program parts in terms of quality improvements is therefore provided. For this purpose, according to various embodiments, a variety of data (i.e. a wide selection of data) are used for the identification. This enables an improvement of the code quality at both the implementation level and the architecture level.

Various embodiments are based on the observation that, in most software projects, the most effective quality improvements (in terms of the effort-to-benefit ratio) are those that focus on a few selected program parts that have the highest complexity or the highest rate of change, or with which the developers are the least familiar (or a combination of these factors). Such program parts are referred to as “hotspots” (i.e., regarded to be critical program parts) because they are the most likely to contain errors.

Based on this observation, the revision (i.e., improvement, e.g. automatic via the software development environment 104, e.g. a corresponding revision tool 108 of the software development environment 104) of a computer program (e.g. application 105) is carried out, for example by:
1. Collecting information about the codebase to be examined, e.g. collecting logs of a version control system of the respective application.
2. Based on the collected information, evaluating program parts in the given codebase by ascertaining evaluations using one or more evaluation routines (referred to hereinafter as evaluators) and deriving criticality evaluation metric values for multiple criticality evaluation metrics from said evaluations. The evaluations are carried out in such a way that they (or the criticality evaluation metric values derived from them) can be used to determine whether a program part is a hotspot or not. For example, the criticality evaluation metric values provide an (overall) criticality value (e.g. by summing them) that can be used as an indication of whether the program part is a hotspot or not (e.g. by comparing it to a limit value); but the criticality evaluation metric values can also be used in a relative manner only, (i.e. a program part, for which the respective criticality evaluation metrics provide a higher criticality value is considered more critical than a program part for which the respective criticality evaluation metric values provide a lower criticality value. See also the sorting described below).
3. Subsequent sorting of the program parts according to their criticality. In other words: a list of program parts in descending order of their criticality is generated, in which the most critical program part is the first element in the list.
4. Deriving measures to improve code quality on the basis of the generated program part list.
5. Initiating (i.e. triggering) or automatically implementing one or more of the derived measures. An example of triggering a measure is creating a new task in a task tracking tool (task tracker) of the respective software project to carry out a code review (by specific developers) on a particular program part, e.g. within a particular class or method. An example of automatically providing a measure is automatically adding a (e.g. high-quality) static code analysis (e.g. with a tool such as Astree) to the CI/CD pipeline of the project for a particular program part, which can be the code in a particular file, a particular class or a particular method, for instance.

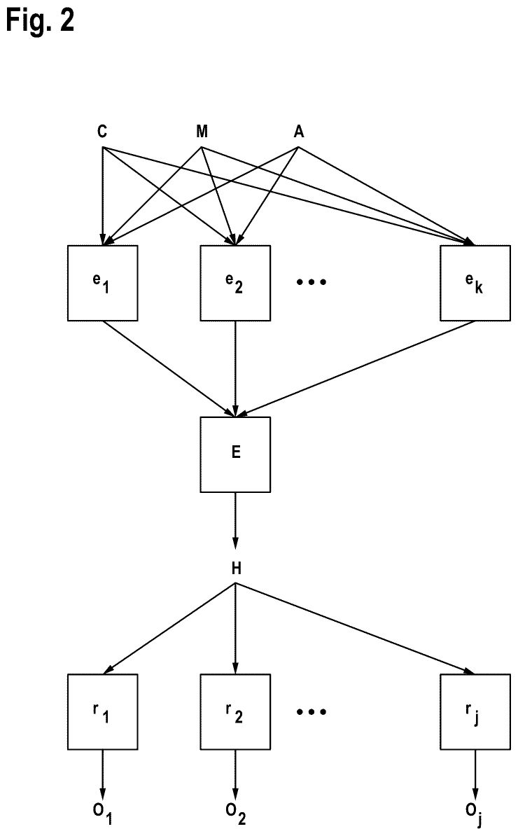

The procedure according to 1 to 5 as described above is explained in more detail in the following with reference to FIG. 2.

FIG. 2 illustrates the ascertainment of revision measures for a computer program using a revision tool (e.g. the revision tool 108).

The revision tool 108 first accepts the following inputs for the computer program (e.g. from a particular software project):
source code metadata M (e.g. Git log or log data from another version control system such as SVN or Mercury)
optionally the source code C
optionally additional information such as historical information about which developers have worked on which code parts or functionalities in previous software projects (e.g. “Developer A worked on cryptographic modules in three previous software projects P1, P2, P3”).

The revision tool 108 contains extractors e₁ to eₖ, into which it enters this input data, M, (optionally) C and (optionally) A e₁ to eₖ. The extractors e₁ to eₖ use specific code characteristics, developer features or auxiliary data to ascertain evaluations that indicate potential code hotspots based on this information. The evaluation ascertained by an extractor for a program part, for example, is a value that is higher the more certain the extractor is that the program part is a code hotspot (i.e. the more critical it is). The ith extractor eᵢ could, for instance, ascertain an evaluation of a program part based on one or more of the following information:
The frequency of changes to the program part (e.g. code of a source code file or source code construct, e.g. class or function). The extractor can obtain this frequency from data from the version control system, e.g. from a Git log. The extractor sets the evaluation for the program part higher the higher the frequency is.
The frequency of errors in the program part. The extractor can obtain this information from historical data of unit tests, for example, (or other regression tests that have a scope that corresponds to the program part (e.g. one or more source code files), i.e. information about which unit tests have failed most frequently. The consideration here is that tests that fail frequently are probably testing code that is prone to errors. The extractor sets the evaluation for the program part higher the higher the frequency is.
The frequency of calls to the program part (e.g. a particular function), i.e. a frequency of execution of the program part during an execution of the computer program. This information can be obtained from data on the frequency of calls to individual functions in a specific software project, as can be ascertained with the aid of software profiling, for example. The consideration here is that quality problems in rarely used functions are probably less critical than in frequently used functions. The extractor sets the evaluation for the program part higher the higher the frequency is.
The degree of exposure, i.e. an evaluation of the extent to which the program part is publicly accessible, i.e. an evaluation of the size of the circle of programmers to which the program part is exposed in terms of possible changes. This degree can be ascertained on the basis of information about which functions, class methods, APIs, etc. are internal and which are public, for example. The consideration here is that functions that are accessible from outside the software project can be accessed by (malicious) users with arbitrary values for their arguments and therefore pose a higher risk if they contain quality problems. The extractor sets the evaluation for the program part higher the higher the degree of exposure of the program part.
The number of errors displayed by code analysis tools for the program part (this can also be considered part of the information about the frequency of errors in the program part). Static code analysis tools display code that potentially contains errors, for instance. In practice, most of these findings are false positive, but the presence of multiple findings typically indicates that the code is more likely to contain quality problems. The extractor sets the evaluation for the program part higher the higher the number is.
The quality evaluation (e.g. experience) of the software developer(s) who wrote the program part. For example, have the developers previously worked on projects written in the same programming language (if yes, the extractor sets the evaluation lower; if no, higher), have they used the same libraries in the past (if yes, the extractor sets the evaluation lower; if no, higher), have they programmed for the same runtime environments or operating systems (if yes, the extractor sets the evaluation lower; if no, higher), have they previously worked in the same domain, e.g. in embedded programming (if yes, the extractor sets the evaluation lower; if no, higher).
The dependencies of the program part (on other parts of the computer program, in particular library routines used in the computer program). The consideration here is that certain dependencies on certain libraries are riskier because they are either known to contain (more) errors or contain functions that could make the software accessible to the outside, e.g. via a computer network. The extractor sets the evaluation for the program part higher the greater the dependencies on libraries classified as high-risk (possibly depending on a respective risk assessment of the libraries).
The complexity of the program part. The extractor sets the evaluation higher the more complex the program part is. The complexity can be evaluated using various criteria such as nesting, the number of specific operations and/or variables used, the type of library functions used, etc.

The evaluations ascertained by the extractors e₁ to eₖ are collected by a master extractor E of the revision tool 108. The master extractor E takes the evaluations of the individual extractors e₁ to eₖ and calculates an (overall) criticality value, i.e. an overall evaluation for each program part under consideration (e.g. file, class or function), and outputs a (possibly ordered) list H of program parts H, wherein each program part is assigned a vector (m₁; . . . ; mₗ) with categorical or numerical metrics for the (evaluation) metrics m1 to ml.

A criticality evaluation metric mᵢ calculated by E can be, for example:
the output value of an extractor eᵢ
a weighted sum of the outputs of the extractors e₁ to eₖ,
a weighted sum of selected extractors, e.g. the extractors e₁, e₅ and e₁₀,
a combination of a logical predicate and a sum, e.g. if e₅>2:5 and e₉<5:0, then the weighted sum of e₃ and e₄ is output, if not it is a different value, etc.

The list H can have the form of a matrix that has n rows, for instance, namely one row for each program part under consideration (of n program parts under consideration), and l columns, namely one column for each criticality evaluation metric mᵢ. For each program part, the overall criticality value can be calculated from the mᵢ, for example by summing the mᵢ. The program parts can then be sorted by descending criticality value (i.e. the rows in H can be sorted in this manner) and H can also be truncated, e.g. rows that have a criticality value below a certain threshold value are discarded (e.g. they are then not considered a “hotspot”, i.e. in that case H then contains only the hotspots.

The H list is used as input for recommenders r₁ to rⱼ. The recommenders output different recommendations for different measures o₁ to oⱼ to improve the quality of the computer program. For example, the output of a recommender can be a (potentially ordered) list of program parts that:
should be revised at the implementation level because they contain technical weaknesses
should be revised at the architecture level
should be subjected to a code review
should be analyzed for errors
should be rewritten in a different programming language to ensure that certain quality problems do not occur
should be verified using a specific/different test, validation or verification strategy (or procedure), e.g. using a different method or a different tool, such as static code analysis
should be validated using a different test strategy, e.g. with formal verification

Every criticality evaluation metric is associated with a respective measure, for example, and a recommender (e.g. likewise associated with the measure) recommends the measure if the value mᵢ of that criticality evaluation metric is above a respective threshold value. The criticality evaluation metric for a program part could, for instance, indicate that the program part
is both complex and long, and a respective recommender then recommends decomposing the program part (e.g. dividing a function into subfunctions)
represents a bottleneck and a respective recommender then recommends revising the architecture of the computer program
is highly exposed and a respective recommender then recommends testing the program part (e.g. a subprogram) by means of fuzzing.

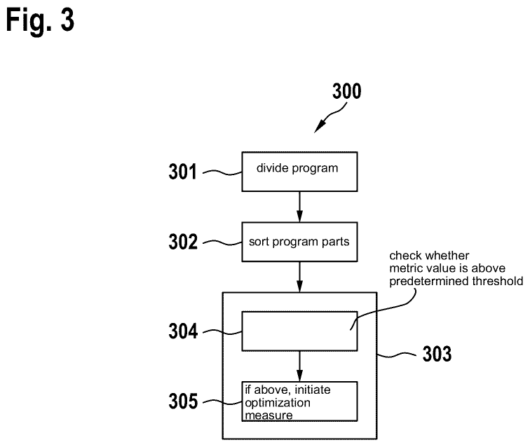

In summary, a method is provided according to various embodiments as shown in FIG. 3.

FIG. 3 shows a flowchart 300 illustrating a method for optimizing a computer program according to an embodiment.

In 301, for dividing the computer program into a plurality of program parts (e.g. the method can include ascertaining this classification), a respective metric value (also referred to as mᵢ in the embodiment examples) is ascertained for each program part based on one or more criteria for each criticality evaluation metric of a plurality of criticality evaluation metrics (wherein the metrics differ in terms of the criteria that they take into account i.e. on the basis of which they are ascertained). Each criticality evaluation metric is assigned an optimization measure (e.g. decomposing the program part e.g. a large function into multiple small functions, changing a library function being used (e.g. copy_n instead of copy) etc.).

In 302, the program parts are sorted based on the metric values according to descending criticality of the program parts (e.g. by ascertaining an (overall) criticality value for each program part by summing the metric values of the program part and sorting the program parts (in descending order) according to the criticality values).

In 303, the program parts are processed in accordance with an order specified by the sorting by
checking, in 304, for each program part to be processed and each criticality evaluation metric, whether the metric value of the criticality evaluation metric is above a predetermined threshold value associated with the criticality evaluation metric, and,
if the metric value of the criticality evaluation metric is above the threshold value, initiating, in 305, an optimization measure that is associated with the criticality evaluation metric.

The optimization measures for the program parts do not have to be carried out in their entirety before the next program part is taken into consideration; the program parts can instead also be combined into groups (e.g. for ranges of criticality values) and the optimization measures can be carried out all together for each group. The optimization measures can alternatively also be carried out individually for each program part.

The method of FIG. 3 can be carried out automatically and can be iterated.

The method of FIG. 3 can, for instance, be carried out (in particular automatically) by one or more computers comprising one or more data processing units. The term “data processing unit” can be understood to mean any type of entity that enables the processing of data or signals. The data or signals can, for example, be processed according to at least one (i.e. one or more than one) specific function carried out by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the respective functions described in more detail here can also be understood as a data processing unit or logic circuitry. One or more of the method steps described in detail here can be carried out (e.g. implemented) by a data processing unit by means of one or more specific functions executed by the data processing unit.

According to various embodiments, therefore, the method is in particular computer-implemented.

For example, the computer program can be a computer program that processes sensor data and generates a control signal for a robot device depending on a result of said processing. The term “robot device” can be understood to mean any technical system (comprising a mechanical part the movement of which is controlled), such as a computer-controlled machine, a vehicle, a household appliance, a power tool, a manufacturing machine, a personal assistant or an access control system.

What is claimed is:

1. A method for optimizing a computer program which, for dividing the computer program into a plurality of program parts, comprises the following steps:
ascertaining a respective metric value for each of the program parts based on one or more criteria for each criticality evaluation metric of a plurality of criticality evaluation metrics, wherein each criticality evaluation metric is assigned an optimization measure;
sorting the program parts based on the metric values according to descending criticality of the program parts; and
processing the program parts in accordance with an order specified by the sorting by checking, for each program part to be processed and each criticality evaluation metric, whether the metric value of the criticality evaluation metric is above a predetermined threshold value associated with the criticality evaluation metric, and, when the metric value of the criticality evaluation metric is above the threshold value, initiating an optimization measure that is associated with the criticality evaluation metric.

2. The method according to claim 1, wherein the one or more criteria are one or more of the following:
a frequency of changes to the program part,
an evaluation by one or more programmers associated with the program part,
an error frequency of the program part,
a frequency of execution of the program part during an execution of the computer program,
an evaluation of a size of a circle of programmers to which the program part is exposed in terms of possible changes,
a degree of dependencies of the program part on other parts of the computer program,
a complexity of the program part.

3. The method according to claim 1, wherein the criticality evaluation metrics combine and/or weight the criteria differently.

4. The method according to claim 1, wherein the optimization measures assigned to the criticality evaluation metrics are one or more of the following:
a revision and/or review at implementation level,
a revision at architecture level,
an error analysis,
a change of the programming language used for the program part,
a verification of the program part with a specific test, and/or validation, and/or verification procedure.

5. The method according to claim 1, wherein the computer program is a control program for a robot device, and the robot device is controlled with a version of the computer program that is generated by the optimization measures initiated by the processing of the program parts.

6. A data processing device, which is configured to optimize a computer program which, for dividing the computer program into a plurality of program parts, the data processing device is configured to:
ascertain a respective metric value for each of the program parts based on one or more criteria for each criticality evaluation metric of a plurality of criticality evaluation metrics, wherein each criticality evaluation metric is assigned an optimization measure;
sort the program parts based on the metric values according to descending criticality of the program parts; and
process the program parts in accordance with an order specified by the sorting by checking, for each program part to be processed and each criticality evaluation metric, whether the metric value of the criticality evaluation metric is above a predetermined threshold value associated with the criticality evaluation metric, and, when the metric value of the criticality evaluation metric is above the threshold value, initiating an optimization measure that is associated with the criticality evaluation metric.

7. A non-transitory computer-readable medium on which is stored instructions for optimizing a computer program, the instructions, when executed by a processor, causing the processor to perform, for dividing the computer program into a plurality of program parts, the following steps:
ascertaining a respective metric value for each of the program parts based on one or more criteria for each criticality evaluation metric of a plurality of criticality evaluation metrics, wherein each criticality evaluation metric is assigned an optimization measure;
sorting the program parts based on the metric values according to descending criticality of the program parts; and
processing the program parts in accordance with an order specified by the sorting by checking, for each program part to be processed and each criticality evaluation metric, whether the metric value of the criticality evaluation metric is above a predetermined threshold value associated with the criticality evaluation metric, and, when the metric value of the criticality evaluation metric is above the threshold value, initiating an optimization measure that is associated with the criticality evaluation metric.
